(19) United States
(12) Patent Application Publication
(10) Pub. No.: US 2016/0183558 A1
(43) Pub. Date: Jun. 30, 2016

(54) RUMINANT FEED COMPOSITIONS AND METHODS OF MAKING AND USING THE SAME

(71) Applicant: BENEMILK OY, Raisio (FI)

(72) Inventors: James Edward NOCEK, Auburn, NY (US); Feng WAN, Issaquah, WA (US); Timothy Martin LONDERGAN, Seattle, WA (US); Jayesh Ramesh BELLARE, Worli, Mumbai (IN); Merja Birgitta HOLMA, Raisio (IN)

(73) Assignee: BENEMILK OY, Raisio (FI)

(21) Appl. No.: 14/909,120

(22) PCT Filed: Jul. 30, 2013
(86) PCT No.: PCT/US13/52639

§ 371 Date: Jan. 31, 2016

(51) Int. Cl. A23K 1/16

(52) U.S. Cl. CPC A23K 1/164; A23K 1/005; A23K 1/1631; A23K 1/1643; A23K 1/1813; A23K 1/175; A23K 1/1646; A23K 1/1603

(57) ABSTRACT

Dietary particle compositions for ruminant feed are disclosed, as well as methods for their preparation and use. The compositions may include a fatty acid compound, a core, and at least one encapsulating agent. The dietary particle may have a core coating layer. The fatty acid compound may be in the core or the core coating layer. The core may include a carbohydrate compound and a protein compound. The fatty acid compound may include at least about 90% saturated fatty acids. The fatty acid compound may include a palmitic acid compound.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

A common approach to increasing either or both production and milk fat contents includes adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, the methods and feeds oftentimes result in other undesired effects, such as increased trans fatty acid levels on the fatty acid profile of the milk fat.

### SUMMARY

In an embodiment, a dietary particle composition may include a core and a core coating layer that has a saturated fatty acid compound. The composition may be encapsulated by at least one encapsulating agent.

In an embodiment, a method of increasing milk fat content may include providing a dietary particle composition to a ruminant for ingestion. The dietary particle composition may have a core. The core may have a saturated fatty acid compound. The core may be encapsulated by an encapsulating agent.

In an embodiment, a method of increasing milk fat content may include providing a dietary particle composition to a ruminant for ingestion. The dietary particle composition may have a core and a coating layer. The coating layer may have a saturated fatty acid compound.

In an embodiment, a method of preparing a dietary particle composition may include heating at least one saturated fatty acid compound to at least its melting point and contacting the saturated fatty acid compound with at least one carrier compound to form a core.

In an embodiment, a method of making a dietary particle composition may include extruding a core material that has a saturated fatty acid compound and coating the core material with a coating layer.

In an embodiment, a method of making a dietary particle composition may include extruding a core material and coating the core material with a coating layer that has a saturated fatty acid compound.

In an embodiment, a dietary particle composition may include a core that has at least one saturated fatty acid compound. The core may be encapsulated by at least one encapsulating agent.

### BRIEF DESCRIPTION OF THE DRAWINGS

FIG. 1 depicts a flowchart of an illustrative method of preparing a dietary particle composition according to an embodiment.

FIG. 2 depicts a flowchart of an illustrative method of making a dietary particle composition according to an embodiment.

FIG. 3 depicts a cross-sectional illustration of a dietary particle composition according to an embodiment.

FIG. 4 depicts a cross-sectional illustration of an alternative dietary particle composition according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “ruminant” is a class of mammal with a multiple chamber stomach that gives the animal an ability to digest cellulose-based food by softening it within the first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

The present disclosure relates generally to dietary compositions such as supplements and the like that can be fed to ruminants for purposes of affecting milk production in the ruminant Particularly, the dietary compositions described herein may be fed to a ruminant to increase the amount of milk produced by the ruminant and/or to increase the fat content of the milk produced by the ruminant, as described in greater detail herein. Specific compositions described herein may be in solid form or semi-solid form, including particles, multi-layer particles, and/or the like, and may be used as dietary feed for ruminants.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of the oil feeding, the milk protein concentration is lowered, the fat concentration is decreased, and the proportion of trans fatty acids is increased. These have been connected especially to an increase in the harmful low-density lipoprotein (LDL) cholesterol and to a decrease in the beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may contain more than 70% saturated fatty acids and total amount of trans fatty acids may vary in the range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake. The salts may also impact the pelletizing process of the feed.

Accordingly, the dietary composition described herein allows for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and fat in the milk rise. Especially, the dietary composition enhances fat synthesis in the mammary gland by bringing milk fat compounds to the cell and therefore the energy consuming synthesis in the mammary gland is not necessary. Thus, glucose can more efficiently be used for lactose production whereupon milk production increases. The milk protein content rises since there is no need to produce glucose from amino acids. Thus, the ruminant therefore does not lose weight at the beginning of the lactation period.

In the various embodiments described herein, a dietary particle composition may include a core that may be encapsulated by at least one encapsulating agent. The dietary particle composition may include a core and a core coating layer that may be encapsulated by at least one encapsulating agent. The core may have a saturated fatty acid compound. The coating layer may have a saturated fatty acid compound.

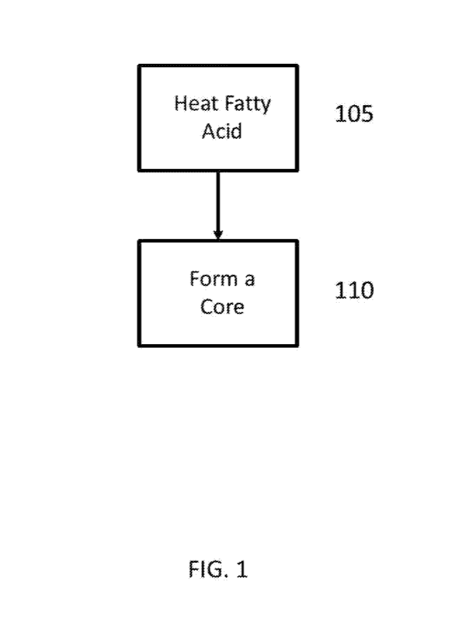

FIG. 1 depicts a flow chart of an illustrative method of preparing a dietary particle composition according to an embodiment. In various embodiments, the compounds described herein with respect to FIG. 1 may generally be combined in any order and/or any combination, and are not limited by the order described herein. In some embodiments, a dietary particle composition may be prepared by heating 105 at least one saturated fatty acid compound and forming 110 a core. Thus, processes 105 and 110 result in combining the saturated fatty acid compound with at least one carrier compound to obtain the dietary particle composition. The dietary particle composition may include a plurality of cores. Processes 105 and 110 may be performed in different orders, or may all be performed simultaneously.

In some embodiments, the at least one saturated fatty acid compound may be heated 105 to at least the melting point of the at least one saturated fatty acid compound. In other embodiments, the at least one saturated fatty acid compound may be heated above the melting point of the at least one saturated fatty acid compound. The melting point of a fatty acid compound rich in saturated fatty acids may be high. In some embodiments, the melting point of the at least one saturated fatty acid compound may be at least about 40° C. In other embodiments, the melting point of the at least one saturated fatty acid compound may be equal to or less than about 80° C. In other embodiments, the melting point of the at least one saturated fatty acid compound may be about 40° C. to about 80° C. For example, the melting point of the at least one saturated fatty acid compound may be about 40° C., about 45° C., about 50° C., about 55° C., about 60° C., about 63° C., about 65° C., about 70° C., about 73° C., about 75° C., about 80° C., or any value or any range between any two of these values. The melting point may generally be selected so that it is a temperature that ensures that the fatty acid is inert in the rumen environment.

The core may be formed 110 by contacting the saturated fatty acid compound with at least one carrier compound. The at least one carrier compound may be a carbohydrate source, a protein source, or a combination thereof. In some embodiments, the core material may be formed by mixing a carbohydrate source, a protein source, and a saturated fatty acid compound. Accordingly, forming 110 may include pressing, molding, extruding, grinding, pelleting, encapsulating, granulating and/or the like. Pressing may include, for example, applying a pressure to an amount of the core. Molding may include, for example, open molding, compression molding, injection molding, centrifugal molding, or the like. Extruding may include, for example, forming an amount of the core by forcing the core through a die having a desired shape and size.

Grinding may be performed by various grinding devices known to those having ordinary skill in the art, such as a hammer mill, a roller mill, a disk mill, or the like. The cores and/or portions thereof may be ground to various sizes, such as particle size (for instance, measured in millimeters), mesh sizes, surface areas, or the like. According to some embodiments, the cores and/or portions thereof may be ground to an average particle size of about particle size of about 0.05 mm to about 10 mm More particularly, the cores may be ground to produce a granular material having an average particle size of about 0.05 mm, about 0.1 mm, about 0.2 mm, about 0.5 mm, about 1.0 mm, about 2.0 mm, about 3.0 mm, about 4.0 mm, about 5.0 mm, about 6.0 mm, about 7.0 mm, about 8.0 mm, about 9.0 mm, about 10.0 mm, or any value or range between any two of these values. In some embodiments, the cores may be ground so that about 20% to 50% of the ground cores are retained by a mesh having openings with a size of about 10 mm and so that about 70% to about 90% of the ground cores are retained by a mesh having openings with a size of about 1 mm. In some embodiments, the various components may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

Grinding may provide various benefits, such as improving certain characteristics of the cores. For instance, even and fine particle size may improve the mixing of different ingredients. According to certain embodiments, grinding may be configured to decrease a particle size of certain components of the cores, for example, to increase the surface area open for enzymes in the gastrointestinal tract, which may improve the digestibility of nutrients, and/or to increase the palatability of the feed.

The cores may be dried to have a water content of about 5% by weight or less. For example, the cores may be dried to have a water content of about 5% by weight, of about 4% by weight, of about 3% by weight, of about 2% by weight, of about 1% by weight, about 0%, or any value or range between any two of these values.

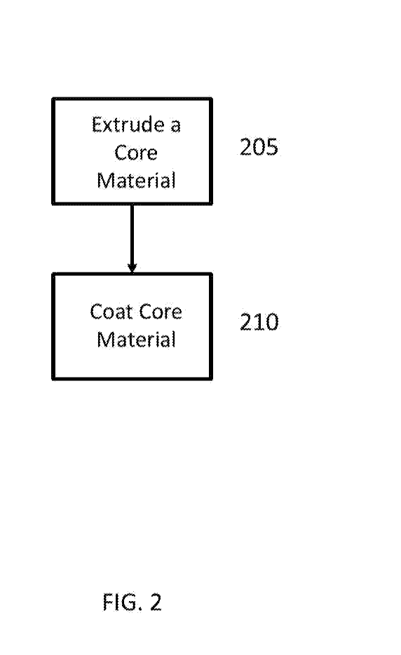

FIG. 2 depicts a flow chart of an illustrative method of making a dietary particle composition according to an embodiment. In various embodiments, the compounds described herein with respect to FIG. 2 may generally be combined in any order and/or any combination, and are not limited by the order described herein. In some embodiments, a dietary particle composition may be made by extruding 205 a core material and coating 210 a core material with a coating layer. In an embodiment, the core material may have a saturated fatty acid compound. In an alternate embodiment, the coating layer may have a saturated fatty acid compound. Thus, processes 205 and 210 result in a core material coated 210 with a coating layer to obtain the dietary particle composition. Processes 205 and 210 may be performed in different orders, or may be performed simultaneously. A core formed 110 in accordance with the teachings of FIG. 1 may be used as the core material in the method illustrated in FIG. 2.

In some embodiments, the core material may be formed by mixing a carbohydrate source, a protein source, and a saturated fatty acid compound. The carbohydrate source and the protein source may be ground to a desired fineness so that a homogeneous core material may be obtained to improve processability during extrusion 205. In some embodiments, the saturated fatty acid compound may be dispersed in water to obtain a liquid suspension or an emulsion.

In various embodiments, the core material may be extruded 205 to produce cores. The cores may be formed into particles. For example, the cores may be pelletized to form particles. Each core may be formed into a cube, a cuboid, a square-based pyramid, a triangular-based pyramid, a triangular prism, a hexagonal prism, a cone, a sphere, a cylinder, or a combination thereof. In some embodiments, the cores may be rounded by any conventional means. For example, the cores may be tumbled or pressed. The cores may have sufficient body or consistency to remain intact during handling. Handling may include the extrusion 205 of the cores, the forming 110 of the cores, the rounding of the cores, and the coating 210 of the core material with a coating layer. In some embodiments, before the cores are coated 210, the cores may be cooled and/or dried.

In various embodiments, the cores may be coated 210 with a coating layer such that the first coating layer substantially covers the surface of the cores. As used herein, “substantially covers” refers to at least about 50% coverage. For example, “substantially covers” may be about 50% coverage, about 55% coverage, about 60% coverage, about 65% coverage, about 70% coverage, about 75% coverage, about 80% coverage, about 85% coverage, about 90% coverage, about 95% coverage, about 99% coverage, about 100% coverage, or any value or range between any of these values. In other embodiments, there may be a plurality of coating layers. In some embodiments, the coating layer compounds may be mixed in a liquid form, a semi-solid form, a solid form, an emulsion form, a paste form, a slurry form, or a combination thereof. In some embodiments, the coating layer compounds may be sprayed on the cores, dusted on the cores, sprinkled on the cores, smeared on the cores, painted on the cores, or a combination thereof.

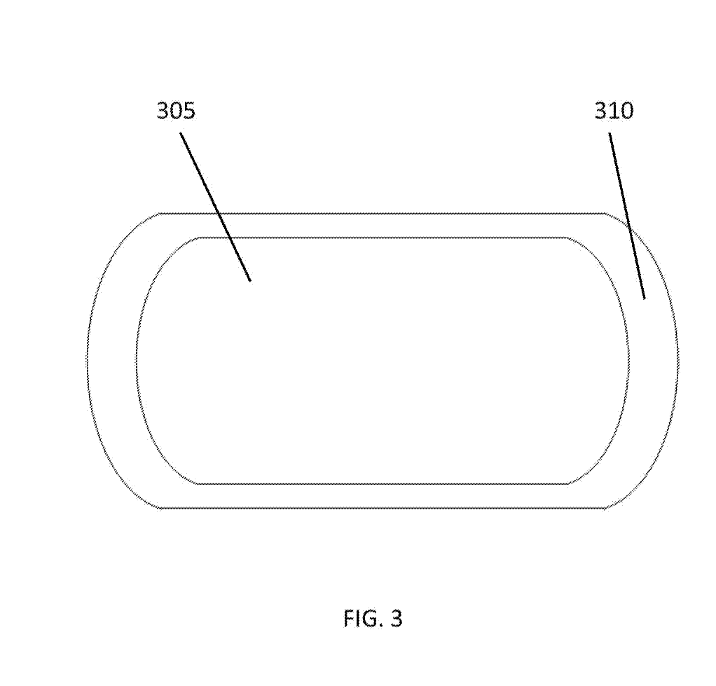

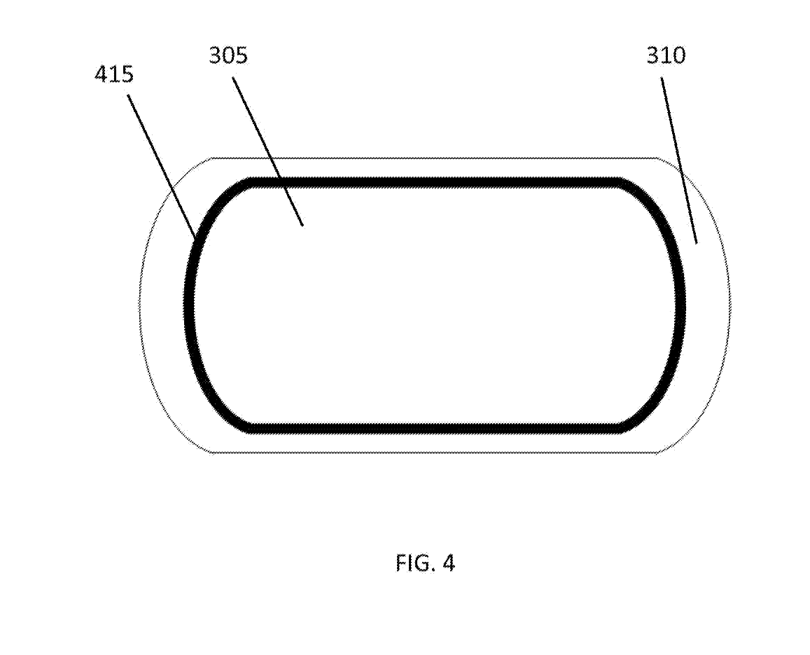

A dietary particle composition is illustrated in FIG. 3. In various embodiments, the dietary particle composition may have a core 305 and the dietary particle composition may be encapsulated by at least one encapsulating agent 310. An alternate dietary particle composition is illustrated in FIG. 4. In some embodiments, the dietary particle composition may additionally have a core coating layer 415. In some embodiments, the core 305 may have at least one fatty acid compound. In other embodiments, the core coating layer 415 may have at least one fatty acid compound.

In various embodiments, a core 305 may include a carbohydrate, a protein, an omega-3 fatty acid, a conjugated linoleic acid (CLA), an amino acid, an amino acid derivative, a mineral, a vitamin, an antioxidant, a glucogenic precursor, and/or the like. The core 305 may include various portions generally included in particular amounts that are sufficient to provide beneficial nutritional and dietary needs of the ruminant that is to consume the dietary composition. For example, a core 305 may include a carbohydrate compound and a protein compound, each in an amount sufficient to provide beneficial nutritional and dietary needs of the ruminant. In some embodiments, the core 305 may include a carbohydrate compound, a protein compound, and a fatty acid compound.

In various embodiments, the core 305 may be present in the dietary composition in an amount of about 5% to about 95% by weight of the dietary composition. In particular embodiments, the core 305 may be present in the dietary composition in an amount of about 5% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, about 85% by weight, about 90% by weight, about 95% by weight, or any value or range between any two of these values.

The carbohydrate is not limited by this disclosure and may include any carbohydrates, particularly those used in animal feed. In some embodiments, the carbohydrate may generally provide a source of energy for the core 305. Illustrative examples of carbohydrates may include molasses, sugar beet pulp, sugarcane, wheat bran, oat hulls, grain hulls, soybean hulls, peanut hulls, wood, brewery byproducts, beverage industry byproducts, forages, roughages, silages, molasses, sugars, starches, cellulose, hemicellulose, wheat, corn, oats, sorghum, millet, barley, barley fiber, barley hulls, barley middlings, barley bran, malting barley screenings, malting parley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

In some embodiments, the protein may be obtained from a protein source. Illustrative examples of protein sources may include one or more grains and/or oilseed meals. The grain is generally not limited by this disclosure and may be any edible grain, or combination of grains, that is used as a protein source. Illustrative examples of grains may include cereal grains such as barley, wheat, spelt wheat, rye, oats, triticale, rice, corn, buck wheat, quinoa, amaranthus, sorghum, and the like. Oilseed meal is generally derived from residue that remains after reserved oil is removed from oilseeds. The oilseed meal may be rich in protein and variable in residual fats and oils. Illustrative examples of oilseed meal may include rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In various embodiments, the omega-3 fatty acid may include one or more of fish oil, algal oil, egg oil, squid oil, krill oil, sea buckthorn seed oil, berry oil, flaxseed oil, Sacha Inchi oil, Echium oil, hemp oil, and/or the like.

In various embodiments, the conjugated linoleic acid (CLA) may include any isomer of linoleic acid. Any isomer of conjugated linoleic acid includes all positional and geometric isomers of linoleic acid with two conjugated carbon-carbon double bonds any place in the molecule. As used herein, “conjugated linoleic acid” or “CLA” refers to any conjugated linoleic acid or octadecadienoic fatty acid. Conjugated linoleic acid differs from ordinary linoleic acid in that ordinary linoleic acid has double bonds at carbon atoms 9 and 12. For example, conjugated linoleic acid may include cis- and trans isomers (“E/Z isomers”) of the following positional isomers: 2,4-octadecadienoic acid, 4,6-octadecadienoic acid, 6,8-octadecadienoic acid, 7,9-octadecadienoic acid, 8,10-octadecadienoic acid, 9,11-octadecadienoic acid, 10,12 octadecadienoic acid, and 11,13 octadecadienoic acid. As used herein, “conjugated linoleic acid” refers to a single isomer, a selected mixture of two or more isomers, and a non-selected mixture of isomers obtained from natural sources, as well as synthetic and semisynthetic conjugated linoleic acid.

In some embodiments, the amino acid may be an essential amino acid, including any combination of leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the core 305 to provide a nutritional aid in various physiological processes in the ruminant, such as, for example, increasing muscle mass, providing energy, aiding in recovery, and/or the like. In some embodiments, the amino acid may be obtained from a premix composition.

In various embodiments, the mineral may be any mineral that is a generally recognized as safe (GRAS) mineral or a combination of such minerals. The mineral may further be obtained from any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include magnesium acetate, magnesium carbonate, magnesium oxide, magnesium sulfate, and/or the like. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like.

In various embodiments, the vitamin may include any combination of vitamin A, vitamin B, vitamin C, vitamin D, vitamin E, vitamin K, and/or the like. Specific examples of vitamin B include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

In various embodiments, the antioxidant may include any molecule that inhibits the oxidation of other molecules. For example, the antioxidant may include alpha-carotene, beta-carotene, ethoxyquin, butylated hydroxyanisole (BHA), butylated hydroxytoluene (BHT), cryptoxanthin, lutein, lycopene, zeaxanthin, uric acid, glutathione, vitamin A, vitamin C, vitamin E, catalase, superoxide dismutase, peroxidases, melatonin, selenium, alpha-lipoic acid, and/or the like.

In various embodiments, the glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, or combinations thereof. The glucogenic precursor may generally be included in the core 305 to provide an energy source to the ruminant so as to prevent gluconeogenesis from occurring within the ruminant's body.

In some embodiments, the core 305 may include an amount of carnitine. The carnitine may be included in the core 305 to aid in the breakdown of fatty acids to generate metabolic energy in the ruminant. In some embodiments, the carnitine may be present in a premix composition.

In various embodiments, the core 305 may include a micronutrient mixture. Micronutrient mixtures are not limited by this disclosure and may generally contain any micronutrient mixture now known or later developed. The micronutrient mixture may include various compounds, such as at least one vitamin and at least one mineral, as described in greater detail herein. In some embodiments, the micronutrient mixture may be present in a premix composition.

In some embodiments, the core 305 may include at least one carrier compound. The at least one carrier compound may be a solid carrier, a semi-solid carrier, or a liquid carrier. In some embodiments, the at least one carrier compound may be a starch, a polysaccharide, a glycolipid, a glycolprotein, a protein, agar, chitosan, carrageenan, collagen, a plasticizer, a wax, or a combination thereof.

In some embodiments, the core 305 may include at least one bulking agent. Illustrative examples of a bulking agent include silicate, kaolin, diatomaceous earth, clay, or a combination thereof.

In some embodiments, the core 305 may include at least one filling agent. The filling agent may generally provide a source of fiber for the ruminant to lower cholesterol levels and promote proper digestive function. Illustrative examples of a filling agent include fiber, corn gluten feed, sunflower hulls, distillers grains, guar hulls, wheat middlings, rice hulls, rice bran, sugar beet pulp, oilseed meals, cottonseed meal, soybean meal, bean meal sunflower meal, linseed meal, peanut meal, rapeseed meal, canola meal, dried blood meal, animal by-product meal, fish by-product, fish meal, dried fish solubles, feather meal, poultry by-products, meat meal, bone meal, dried whey, soy protein concentrate, soy flour, yeast, wheat, oats, grain sorghums, corn feed meal, rice, rye, corn, barley, aspirated grain fractions, brewers dried grains, corn flour, feeding oat meal, sorghum grain flour, wheat mill run, wheat red dog, hominy feed, wheat flour, wheat bran, wheat germ meal, oat groats, rye middlings, cotyledon fiber, ground grains, wheat grain, corn grain, milo grain, or a combination thereof.

In various embodiments, the core 305 may include at least one emulsifying agent. In a particular embodiment, the at least one emulsifying agent may have both emulsifying and pelletizing effects. In some embodiments, the at least one emulsifying agent may be non-ionic. The emulsifier is not limited by this disclosure, and may generally be any composition that is capable of emulsifying the dietary particle composition. Specific examples of emulsifiers may include lecithin, polyoxyethylene stearate, polyoxyethylene sorbitan monolaurate, polyoxyethylene sorbitan, polyoxyethylene, sorbitan monopalmitate, polyoxyethylene sorbitan monostearate, polyoxyethylene sorbitan tristearate, ammonium phosphatides, salts of fatty acids, glycerides of fatty acids, acetic acid esters of glycerides of fatty acids, lactic acid esters of glycerides of fatty acids, citric acid esters of fatty acids, acetyl tartaric acid esters of fatty acids, sucrose esters of fatty acids, sucroglycerides, polyglycerol esters of fatty acid, polyglycerol polyricinoleate, propane-1,2-diol esters of fatty acids, oxidized soya bean oil glycerides, castor oil glycerides, sodium stearoyl-2-lactylate, calcium stearoyl-2-lactylate, sorbitan monostearate, sorbitan tristearate, sorbitan monolaurate, sorbitan monooleate, sorbitan monopalmitate, or a combination thereof. Castor oil may be effective as an emulsifier because of its ability to render oil soluble in water.

In various embodiments, the emulsifier may have a hydrophilic-lipophilic balance HLB of about 5 to about 14. In particular embodiments, the HLB of the emulsifier may be about 5, about 6, about 7, about 8, about 9, about 10, about 11, about 12, about 13, about 14, or any value or range between any two of these values.

In various embodiments, the emulsifier may be present in the dietary particle composition in an amount of about 0.01% by weight to about 2.0% by weight of the dietary particle composition. For example, the emulsifier may be present in the dietary particle composition in an amount of about 0.01% by weight, about 0.02% by weight, about 0.04% by weight, about 0.06% by weight, about 0.08% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values. In some embodiments, the emulsifier may be present in the dietary particle composition in an amount of about 0.2% by weight to about 2.0% by weight of the saturated fatty acid. For example, the emulsifier may be present in the dietary particle composition in an amount of about 0.2% by weight, about 0.25% by weight, about 0.3% by weight, about 0.5% by weight, about 0.6% by weight, about 0.75% by weight, about 0.8% by weight, about 1.0% by weight, about 1.2% by weight, about 1.25% by weight, about 1.5% by weight, about 1.75% by weight, about 2.0% by weight, or any value or range between any two of these values.

In various embodiments, the core 305 may include at least one nutritive compound. The nutritive compound is not limited by this disclosure, and may generally be any composition that is capable of providing nutrition to the dietary particle composition. Specific examples of nutritive compounds may include a protein, an amino acid, a vitamin, a mineral, an antioxidant, a lipid, a glycolipid, a polysaccharide, a carbohydrate, a glucogenic precursor, alanine, arginine, asparagine, aspartic acid, cysteine, glutamic acid, glutamine glycine, histidine, isoleucine, leucine, lysine, methionine, phenylalanine, proline, serine, threonine, tryptophan, tyrosine, valine, carnitine, vitamin A, vitamin C, vitamin D, vitamin E, vitamin K, vitamin B1, vitamin B2, pantothenic acid, niacin, biotin, choline, calcium, sodium, magnesium, phosphorus, potassium, minerals, chelated minerals, selenium yeast, zinc, selenium, copper, iodine, iron, cobalt, manganese, molybdenum, glycerol, propylene glycol, molasses, propionate, glycerin, propanediol, calcium propionate, calcium acetate, calcium carbonate, calcium chloride, calcium gluconate, calcium hydroxide, calcium iodate, calcium iodobehenate, calcium oxide, calcium sulfate anhydrous, calcium sulfate dihydrate, cobalt acetate, cobalt carbonate, cobalt chloride, cobalt oxide, cobalt sulfate, dicalcium phosphate, magnesium acetate, magnesium carbonate, magnesium oxide, magnesium sulfate, manganese carbonate, manganese chloride, manganese citrate, manganese gluconate, manganese orthophosphate, manganese oxide, manganese phosphate dibasic, manganese sulfate, monocalcium phosphate, monosodium phosphate, potassium acetate, potassium bicarbonate, potassium carbonate, potassium chloride, potassium iodate, potassium iodide, potassium sulfate, sodium acetate, sodium chloride, sodium bicarbonate, disodium phosphate, iron ammonium citrate, iron carbonate, iron chloride, iron gluconate, iron oxide, iron phosphate, iron pyrophosphate, iron sulfate, reduced iron, sodium iodate, sodium iodide, sodium tripolyphosphate, sodium sulfate, tricalcium phosphate, zinc acetate, zinc carbonate, zinc chloride, zinc oxide, zinc sulfate, or any combination thereof.

In some embodiments, the at least one encapsulating agent 310 may be substantially free of saturated fatty acid. As used herein, “substantially free” means at most 5%. For example, “substantially free” may generally include about 5% by weight, about 4% by weight, about 3% by weight, about 2% by weight, about 1% by weight, about 0.5% by weight, about 0% by weight, or any value or range between any of these values. In some embodiments, the at least one encapsulating agent 310 may be a glidant, a lubricant, an anti-adherent, a sorbent, or a combination thereof. Specific examples of encapsulating agents 310 may include a protein, a polypeptide, a lipid, an emulsifier, a surfactant, a micelle, a carbohydrate, a polysaccharide, a polyvinyl, a plastic, a biodegradable polymer, xanthan gum, guar gum, starch, gum arabic, tragacanth gum, dextran, chitosan, polyvinylpyrrolidone, polyacrylamide, poly(styrene/acrylonitrile), poly(styrene/2-vinylpyridine), poly(ethylene oxide), poly(vinyl acetate), hydroxypropylcellulose, ethylcellulose, cellulose acetate, carboxymethylcellulose, zein, alginate, gelatin, shellac, or a combination thereof.

In some embodiments, the core coating layer 415 may cover at least partially the core surface. As used herein “at least partially” refers to any percentage greater than 1%. In some embodiments, the core coating layer 415 may be substantially free of unsaturated fatty acid. The core coating layer 415 may include one or more of starch, wax, silica, mineral, or a combination thereof. Other ingredients may be optionally included in the core coating layer 415 to facilitate the coating process. For example, other ingredients may be glidants, lubricants, anti-adherents, sorbents, and/or the like.

In various embodiments, the fatty acid compound may generally include one or more free fatty acids and/or glycolipids. Free fatty acids may generally be unconjugated fatty acids, whereas glycolipids may be fatty acids conjugated with a carbohydrate. In some embodiments, the dietary particle composition may not include a trans fatty acid compound. In various embodiments, the fatty acid compound may include at least one saturated fatty acid compound. For example, the fatty acid compound may include 1, 2, 3, 4, 5, 6, or more different saturated fatty acids. In some embodiments, the saturated fatty acid compound may be present in the fatty acid compound in an amount that results in a ruminant consuming the dietary composition to produce a desired quality and quantity of milk, as described in greater detail herein. The fatty acid compound may contain a high amount of saturated fatty acids. The fatty acid compound may include at least 90% of saturated fatty acids. In some embodiments, the fatty acid compound may be a saturated fatty acid compound. In some embodiments, the saturated fatty acid compound may be a palmitic acid compound. In other embodiments, the saturated fatty acid compound may be at least 90% palmitic acid.

Thus, in some embodiments, the saturated fatty acid may be present in an amount of about 90% by weight of the fatty acid compound to about 100% by weight of the fatty acid compound, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like. In a particular embodiment, the fatty acid compound may be a saturated fatty acid compound.

In some embodiments, the saturated fatty acid compound may be present in the dietary particle composition in an amount of at least about 10% by weight of the dietary particle composition. For example, the saturated fatty acid compound may be present in the dietary particle composition in an amount of about 10% by weight, about 15% by weight, about 20% by weight, about 25% by weight, about 30% by weight, about 35% by weight, about 40% by weight, about 45% by weight, about 50% by weight, about 60% by weight, about 70% by weight, about 80% by weight, about 90% by weight, or any value or range between any two of these values. In some embodiments, the saturated fatty acid compound may be present in the core 305 of the dietary particle composition.

In some embodiments, the at least one trans fatty acid compound may be present in the core 305 in an amount of about 5% by weight or less of the dietary particle composition. For example, the at least one trans fatty acid compound may be present in the core 305 in an amount of about 5% by weight, about 4% by weight, about 3% by weight, about 2% by weight, about 1% by weight, about 0.5% by weight, about 0.1% by weight, 0% by weight, or any value or range between any two of these values. In other embodiments, the at least one trans fatty acid compound may be present in the core coating layer 415 in an amount of about 5% by weight or less of the dietary particle composition. For example, the at least one trans fatty acid compound may be present in the core coating layer 415 in an amount of about 5% by weight or less, 4% by weight or less, 3% by weight or less, 2% by weight or less, 1% by weight or less, 0.5% by weight or less, 0.1% by weight or less, or any value or range between any two of these values.

As used herein, the term “salt” of the fatty acid may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

The term “fatty acid ester” as used herein means an ester of a fatty acid. For example, the fatty acid ester may be in a form of RCOOR′. R may be any saturated or unsaturated alkyl group including, without limitation, C10, C12, C14, C16, C18, C20, and C24. R′ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

As used herein, a “fatty acid amide” may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A “fatty acid anhydride” may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An “alcohol” of a fatty acid refers to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the saturated fatty acid compound may be a palmitic acid, a palmitate salt, a palmitate ester, a palmitate amide, a palmitate anhydride, or a combination thereof. In some embodiments, the saturated fatty acid compound includes at least about 60% palmitic acid. For example, the saturated fatty acid compound contains about 60% palmitic acid, about 70% palmitic acid, about 80% palmitic acid, about 90% palmitic acid, about 92% palmitic acid, about 95% palmitic acid, or any value or range between any two of these values. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like.

The palmitic acid compound may be present in the saturated fatty acid compound in an amount of at least about 60% by weight of the fatty acid to at least about 100% by weight of the fatty acid compound. For example, the palmitic acid may be present in the saturated fatty acid compound in an amount of at least about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values. In some embodiments, the saturated fatty acid compound may consist essentially of the palmitic acid compound. In other embodiments, the saturated fatty acid compound may be entirely composed of the palmitic acid compound.

In some embodiments, the palmitic acid compound may be present in the core 305 at a concentration of at least about 10% by weight of the core 305 to about 50% by weight of the core 305. For example, the palmitic acid compound may be present in the core 305 at a concentration of at least 10% by weight, 15% by weight, 20% by weight, 25% by weight, 30% by weight, 35% by weight, 40% by weight, 45% by weight, 50% by weight, or any value or range between any of these values.

In some embodiments, the saturated fatty acid compound may be a stearic acid compound. In some embodiments, the saturated fatty acid compound may be stearic acid, a stearate salt, a stearate ester, a stearate amid, a stearate anhydride, or a combination thereof. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the saturated fatty acid compound in an amount of about 30% or less by weight of the fatty acid compound. In particular embodiments, the stearic acid compound may include about 30% by weight of the saturated fatty acid compound, about 25% by weight of the saturated fatty acid compound, about 20% by weight of the saturated fatty acid compound, about 15% by weight of the saturated fatty acid compound, about 10% by weight of the saturated fatty acid compound, about 5% by weight of the saturated fatty acid compound, or any value or range between any two of these values.

In some embodiments, the stearic acid compound may be present in the core 305 at a concentration of about 30% by weight of the core 305 or less. For example, the stearic acid compound may be present in the core 305 at a concentration of about 30% by weight of the core, about 25% by weight of the core, about 20% by weight of the core, about 15% by weight of the core, about 10% by weight of the core, about 5% by weight of the core, about 1% by weight of the core, or any value or range between any of these values.

In some embodiments, the dietary particle composition may include a first saturated fatty acid compound and a second saturated fatty acid compound. The first saturated fatty acid compound may be a palmitic acid compound. The second saturated fatty acid compound may be a stearic acid compound. The first saturated fatty acid compound and second saturated fatty acid compound may be a mixture. In some embodiments, the first saturated fatty acid compound may be a palmitic acid compound present in the core 305 at a concentration of at least about 10% by weight. In some embodiments, the second saturated fatty acid compound may be a stearic acid compound present in the core 305 at a concentration of about 30% by weight or less. In other embodiments, the palmitic acid compound and the stearic acid compound may have a molar ratio of at least about 1:1 to at least about 15:1. For example, the palmitic acid compound and the stearic acid compound may have a molar ratio of at least about 1:1, about 2:1, about 3:1, about 4:1, about 5:1, about 6:1, about 7:1, about 8:1, about 9:1, about 10:1, about 12:1, about 14:1, about 15:1, or any value or range between any two of these values.

In various embodiments, at least a portion of the saturated fatty acid compound may be contained. In some embodiments, the saturated fatty acid compound may be pre-contained prior to heating 105 the saturated fatty acid compound. In other embodiments, the saturated fatty acid compound may be contained as a result of the various processes 105, 110 described herein. In some embodiments, the saturated fatty acid compound may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment begins to match the physical and chemical characteristics of bulk water. The resulting inverse micelle may be referred to as a microemulsion of water in oil.

In some embodiments, at least a portion of the saturated fatty acid compound may be contained in a micelle core or a vesicle core. The micelle core or vesicle core may include any number of particles therein in addition to the saturated fatty acid compound. The micelle core or vesicle core composition may be made of a material that includes at least one of the protein material, the cellulosic material, the amino acid, and the amino acid derivative, as described in greater detail herein.

In various embodiments, at least a portion of the saturated fatty acid compound may be encapsulated. In some embodiments, the saturated fatty acid compound may be pre-encapsulated prior to heating 105 the saturated fatty acid compound. In other embodiments, the saturated fatty acid compound may be encapsulated as a result of the various processes 105, 110 described herein. In some embodiments, the saturated fatty acid compound may generally be encapsulated by a capsule. The capsule may include a capsule shell, which is made up of at least one polysaccharide. Illustrative examples of capsule shells as described herein may include capsule shells including agar, gelatin, starch casein, chitosan, soya bean protein, safflower protein, alginates, gellan gum, carrageenan, xanthan gum, phthalated gelatin, succinated gelatin, cellulosephthalate-acetate, polyvinylacetate, hydroxypropyl methylcellulose, polyvinylacetate-phthalate, polymerisates of acrylic esters, polymerisates of methacrylic esters, and/or mixtures thereof

In various embodiments, a method of increasing milk fat content in ruminants may include providing the dietary particle composition as described herein to the ruminant for ingestion. In particular embodiments, the dietary particle composition may include a core 305 that may be encapsulated by an encapsulating agent 310, as described in greater detail herein. In some embodiments, there may additionally be a core coating layer 415. In some embodiments, the dietary particle composition may have a saturated fatty acid compound. The saturated fatty acid compound may be in the core 305. The saturated fatty acid compound may be in the core coating layer 415. In some embodiments, the method may additionally include obtaining milk from the ruminant.

In some embodiments, the dietary composition may be provided to the ruminant in an amount that the ruminant receives at least about 10 grams of dietary particle composition per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the dietary particle composition, and/or the like. In some embodiments, the ruminant may be provided with additional amounts of the dietary composition to make up for portions of the dietary particle composition that are not consumed by the ruminant such as amounts that are spilled by the ruminant when consuming the dietary particle composition and/or the like.

In some embodiments, providing the dietary composition to the ruminant for the ruminant to consume may result in an increase in production of milk and/or an increase in fat content of the milk produced. These increases may generally be relative to a similar ruminant that does not receive the dietary particle composition, an average of similar ruminants not receiving the dietary particle composition, an average of the milk production quantity and fat content of the same ruminant when not provided the dietary particle composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values.

### EXAMPLES

### Example 1

### Making a Dietary Particle Composition

A dietary particle composition to be used as ruminant feed is made using a process of extruding a core material with a saturated fatty acid compound, and coating the core material with a coating layer. The saturated fatty acid compound is combined in an amount that is about 60% by weight of the dietary particle composition. The saturated fatty acid compound includes about 70% by weight of palmitic acid, about 30% by weight of stearic acid and no unsaturated trans fatty acids. The dietary particle composition also includes 5% by weight of a feed ingredient to include additional nutrients not currently present and/or lacking in the ruminant's current feed. The core material includes sugar beet pulp, glycerol, propane diol, glutathione, octadecadienoic fatty acid, silicate, vitamin A, riboflavin, biotin, folic acid, vitamin D, carnitine, a phenylalanine derivative, calcium, iron, corn meal, hay meal, lecithin, and straw.

### Example 2

### Feeding a Dairy Cow

A dairy cow that has a normal (untreated) average daily production of 30 kg milk is provided with a dietary particle composition to increase the milk fat and the quantity of the milk produced. The dietary particle composition are pellets that include a core material that is encapsulated by cellulose acetate, a saturated fatty acid compound that is about 50% by weight of the dietary particle composition. The saturated fatty acid compound includes about 70% by weight of palmitic acid, about 20% by weight of stearic acid and no unsaturated trans fatty acids. The dietary particle composition also includes 30% by weight of the core having at least molasses, cobalamin, barley, wheat, choline, omega-3 fatty acid, glycerol, vitamin E, arginine, leucine, catalase, 2,4-octadecadienoic acid, phenylalanine, calcium, sodium, copper, iron, soy meal, and straw.

The dairy cow is given about 300 grams of the dietary particle composition to eat in the morning to ensure that the cow consumes 10 grams of palmitic acid for every kilogram of milk that the cow produces that day. As a result, the cow produces 15% more milk than the cow did previously, and the milk that the cow produces contains 15% more milk fat content than the milk the cow produced previously.

### Example 3

### Providing to a Large Group of Cows

The dietary particle composition as described above with respect to Example 2 is provided to a large group of cows on a commercial dairy farm to confirm its effectiveness. 150 dairy cows from the commercial dairy farm are selected at random to provide a wide variety of variation in various characteristics, such as breed, weight, age of the cow, and the like. Each day, a first group of 75 cows are fed the dietary particle composition. A control group of the remaining 75 cows are fed a standard TMR feed. The 150 cows are monitored for the amount and type of feed consumed, changes in weight, an amount of milk the cow produces each day, and the composition of the milk produced by the cow each day. Monitoring continues for a period of 30 days. A comparison of the two groups of cows over this period of time shows a statistically significant improvement from the group that consumed the dietary particle composition feed over the control group that consumed the standard TMR feed.

In the above detailed description, reference is made to the accompanying drawings, which form a part hereof. In the drawings, similar symbols typically identify similar compounds, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various compounds or steps (interpreted as meaning “including, but not limited to”), the compositions, methods, and devices can also “consist essentially of” or “consist of” the various compounds and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A dietary particle composition comprising:
a core having at least one saturated fatty acid compound and an emulsifying agent, wherein the core is encapsulated by at least one encapsulating agent.

2. The dietary particle composition of claim 1, wherein the at least one encapsulating agent is substantially free of saturated fatty acid.

3. The dietary particle composition of claim 1, wherein the core further comprises a carbohydrate compound and a protein compound.

4. The dietary particle composition of claim 1, wherein the at least one saturated fatty acid compound is present in the core at a concentration of at least about 50% by weight.

5. The dietary particle composition of claim 1, wherein at least one trans fatty acid compound is present in the core at a concentration of 5% by weight or less of the composition.

6. The dietary particle composition of claim 1, wherein the composition does not comprise a trans fatty acid compound.

7. The dietary particle composition of claim 1, wherein the at least one saturated fatty acid compound is a palmitic acid compound selected from the group consisting of a palmitic acid, a palmitate salt, a palmitate ester, a palmitate amide and a palmitate anhydride.

8. (canceled)

9. The dietary particle composition of claim 1, wherein the at least one saturated fatty acid compound is a stearic acid compound selected from the group consisting of stearic acid, a stearate salt, a stearate ester, a stearate amide, and a stearate anhydride.

10. (canceled)

11. The dietary particle composition of claim 1, wherein the at least one saturated fatty acid compound includes a first saturated fatty acid compound and a second saturated fatty acid compound, wherein the first saturated fatty acid compound is a palmitic acid compound and the second saturated fatty acid compound is a stearic acid compound.

12. The dietary particle composition of claim 1, wherein the at least one saturated fatty acid compound is present in the core at a concentration of at least about 10% by weight.

13.-15. (canceled)

16. The dietary particle composition of claim 1, wherein the at least one saturated fatty acid compound includes a first saturated fatty acid compound and a second saturated fatty acid compound, wherein:
the first saturated fatty acid compound is a palmitic acid compound present in the core at a concentration of at least about 10% by weight; and
the second saturated fatty acid compound is a stearic acid compound present in the core at a concentration of at about 30% by weight or less.

17.-19. (canceled)

20. The dietary particle composition of claim 1, wherein the core further comprises a carrier compound selected from the group consisting of a starch, a polysaccharide, a glycolipid, a glycoprotein, a protein, agar, chitosan, carrageenan, collagen, a plasticizer and a wax.

21. The dietary particle composition of claim 1, wherein the core further comprises at least one carrier compound including a solid carrier or a semi-solid carrier.

22. (canceled)

23. The dietary particle composition of claim 1, wherein the core further comprises a bulking agent selected from the group consisting of a silicate, a kaolin, a diatomaceous earth, and a clay.

24. (canceled)

25. The dietary particle composition of claim 1, wherein the core comprises at least one filling agent.

26.-27. (canceled)

28. The dietary particle composition of claim 1, wherein the emulsifying agent is non-ionic.

29. The dietary particle composition of claim 1, wherein emulsifying agent is present in the composition at a concentration of at least about 0.2% by weight.

30.-33. (canceled)

34. The dietary particle composition of claim 1, wherein the emulsifying agent has a hydrophobic-lipophilic balance of about 5 to about 14.

35. (canceled)

36. The dietary particle composition of claim 1, wherein the emulsifying agent is selected from the group consisting of lecithin, polyoxyethylene stearate, polyoxyethylene sorbitan monolaurate, polyoxyethylene sorbitan, polyoxyethylene, sorbitan monopalmitate, polyoxyethylene sorbitan monostearate, polyoxyethylene sorbitan tristearate, ammonium phosphatides, salts of fatty acids, glycerides of fatty acids, acetic acid esters of glycerides of fatty acids, lactic acid esters of glycerides of fatty acids, citric acid esters of fatty acids, acetyl tartaric acid esters of fatty acids, sucrose esters of fatty acids, sucroglycerides, polyglycerol esters of fatty acid, polyglycerol polyricinoleate, propane-1,2-diol esters of fatty acids, oxidized soya bean oil glycerides, castor oil glycerides, sodium stearoyl-2-lactylate, calcium stearoyl-2-lactylate, sorbitan monostearate, sorbitan tristearate, sorbitan monolaurate, sorbitan monooleate and sorbitan monopalmitate.

37. (canceled)

38. The dietary particle composition of claim 1, wherein the core further comprises at least one nutritive compound selected from the group consisting of a protein, an amino acid, a vitamin, a mineral, an antioxidant, a lipid, a glycolipid, a polysaccharide, a carbohydrate and a glucogenic precursor.

39.-66. (canceled)

67. A method of increasing fat content in milk, the method comprising:
providing a dietary particle composition to a ruminant for ingestion, wherein the dietary particle composition comprises a core including an emulsifying agent and a coating layer having a saturated fatty acid compound.

68. The method of claim 67, further comprising obtaining milk from the ruminant.

69. The method of claim 67, wherein the providing comprises providing an amount of at least 10 grams of dietary particle composition per kilogram of milk produced.

70. The method of claim 67, wherein the providing comprises providing an amount of at least 10 grams dietary particle composition per kilogram of milk produced per day.

71. The method of claim 67, wherein milk produced by the ruminant provided the dietary particle composition has a higher level of fat as compared to milk produced by a similar ruminant not provided the dietary particle composition.

72. A method of preparing a dietary particle composition, the method comprising:
heating at least one saturated fatty acid compound to at least its melting point;
contacting the saturated fatty acid compound with at least one carrier compound to form a core;
extruding the core; and
coating the core with a coating layer.

73. The method of claim 72, further comprising drying the core to have a water content of about 5% by weight or less.

74.-75. (canceled)
